(19) United States
(12) Patent Application Publication
(10) Pub. No.: US 2014/0237368 A1
(43) Pub. Date: Aug. 21, 2014

(54) PROXYING NON-INTERACTIVE CONTROLS TO ENABLE NARRATION

(71) Applicant: MICROSOFT CORPORATION, Redmond, WA (US)

(72) Inventor: James Andrew Canitz, Kirkland, WA (US)

(73) Assignee: Microsoft Corporation, Redmond, WA (US)

(21) Appl. No.: 13/769,823

(22) Filed: Feb. 19, 2013

(51) Int. Cl. G06F 3/16

(52) U.S. Cl. CPC G06F 3/167
USPC 715/729

(57) ABSTRACT

In one embodiment, a user interface narrator may use a narration proxy 312 to ensure that non-interactive user interface 308 items may be read by the narration control 212 of an operating system 210. The user interface narrator may use a narration control 212 of an operating system 210 to vocalize a user interface 222. The user interface narrator may detect a narration proxy 312 representing a user interface item 304. The user interface narrator may vocalize the narration proxy 312 with the narration control 212.

### BACKGROUND

Generally, a software application being executed by a computer may interact with a user via a graphical user interface. The user may use a touchpad, keyboard, mouse, or other input device to enter commands to be carried out by the software application. The graphical user interface may present links, controls, data, or other interactive options to the user in a visual form such as text or images. A person with impaired vision may then be unable to satisfactorily interact with the software application.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to using a narration proxy to ensure that non-interactive user interface items are read by the narration control of an operating system. The user interface narrator may use a narration control of an operating system to vocalize a user interface. The user interface narrator may detect a narration proxy representing a user interface item. The user interface narrator may vocalize the narration proxy with the narration control.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing device.

FIG. 2 illustrates, in a block diagram, one embodiment of a software application interaction.

FIG. 3 illustrates, in a block diagram, one embodiment of a graphical user interface.

FIG. 4 illustrates, in a flowchart, one embodiment of a method for presenting a user interface item to a narration control.

FIG. 5 illustrates, in a flowchart, one embodiment of a method for vocalizing a user interface item with a narration control.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a user interface narrator for a computing device.

To improve interactions with users, particularly sight-impaired users, a computing device may use a user interface narrator to vocalize user interface items, such as graphics and text. Vocalizing is the creation of audio data to be played to the user representing the user interface items. Rather than have each application module provide narration of the application user interface, an operating system may have a narration control to narrate whichever user interface item has received input control focus, such as a keyboard focus. Input control focus refers to the element of the graphical user interface prepared to receive user selection. Normally, keyboard focus may be applied to an interactive user interface item. An application module may use a narration proxy to obtain keyboard focus for a non-interactive user interface item, such as a text block. The application module may also use the narration proxy to provide alternate control functions to interactive user interface items.

An application module may provide a narration proxy to allow a user interface item, such as a text block, that normally fails to interact with the accessibility functionality of an operating system. The narration proxy may allow a user interface item to receive input control focus, such as keyboard focus, and be read by a narration control of an operating system.

The narration proxy may be an extendible application markup language wrapping of a user interface item. As keyboard focus often defaults to not applying to a text block, a vision impaired user may not detect text on the screen, such as a contact's e-mail address. The narration proxy may allow the keyboard focus to stop on the text block and provide the narration data to the narration control. The narration proxy may ask the text block for the narration data to provide to the narration control.

Similar to any application provided custom control that seeks to interact with the narration control, the narration proxy may implement an automation peer function to provide a custom automation peer that an operating system may query to retrieve the narration data for the user interface item. The automation peer function may create and wrap an automation peer for the user interface item.

The application module may ask the narration control for a pre-existing control to act as a narration proxy if available. If the narration control does not have a pre-existing control, then the application may create a narration proxy instead.

The narration control may ask the narration proxy for narration data, such as the name of the user interface item. The narration proxy may pull the data from the user interface item and provide that narration data to the narration control.

Thus, in one embodiment, a user interface narrator may use a narration proxy to ensure that non-interactive user interface items may be read by the narration control of an operating system. The user interface narrator may use a narration control of an operating system to vocalize a user interface. The user interface narrator may detect a narration proxy representing a user interface item. The user interface narrator may vocalize the narration proxy with the narration control.

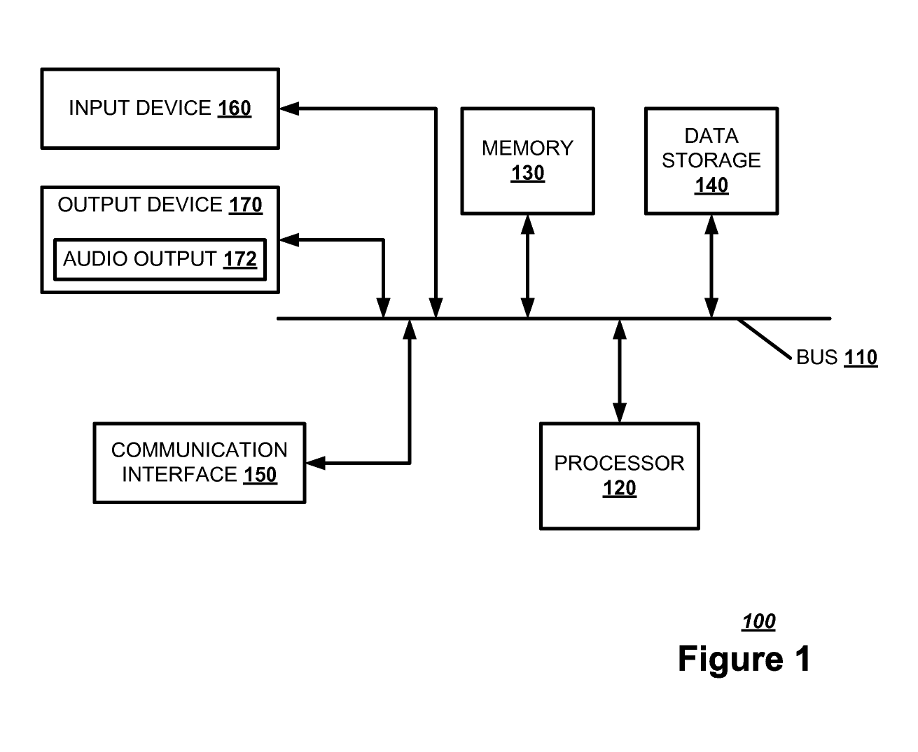

FIG. 1 illustrates a block diagram of an exemplary computing device 100 which may act as a user interface narrator. The computing device 100 may combine one or more of hardware, software, firmware, and system-on-a-chip technology to implement a user interface narrator. The computing device 100 may include a bus 110, a processor 120, a memory 130, a data storage 140, a communication interface 150, an input device 160, and an output device 170. The bus 110, or other component interconnection, may permit communication among the components of the computing device 100.

The processor 120 may include at least one conventional processor or microprocessor that interprets and executes a set of instructions. The memory 130 may be a random access memory (RAM) or another type of dynamic data storage that stores information and instructions for execution by the processor 120. The memory 130 may also store temporary variables or other intermediate information used during execution of instructions by the processor 120. The data storage 140 may include a conventional ROM device or another type of static data storage that stores static information and instructions for the processor 120. The data storage 140 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 140 may store a set of instructions detailing a method that when executed by one or more processors cause the one or more processors to perform the method. The data storage 140 may also be a database or a database interface for storing an application module.

The communication interface 150 may include any transceiver-like mechanism that enables computing device 100 to communicate with other devices or networks. The communication interface 150 may include a network interface or a transceiver interface. The communication interface 150 may be a wireless, wired, or optical interface.

The input device 160 may include one or more conventional mechanisms that permit a user to input information to the computing device 100, such as a keyboard, a mouse, a voice recognition device, a microphone, a headset, a gesture recognition device, a touch screen, etc. The output device 170 may include one or more conventional mechanisms that output information to the user, including a display, a printer, or a medium, such as a memory, or a magnetic or optical disk and a corresponding disk drive. Specifically, the output device 170 may be an audio output 172, such as a speaker or headset, to convey information to a user in an audio format.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the data storage 140, or from a separate device via the communication interface 150.

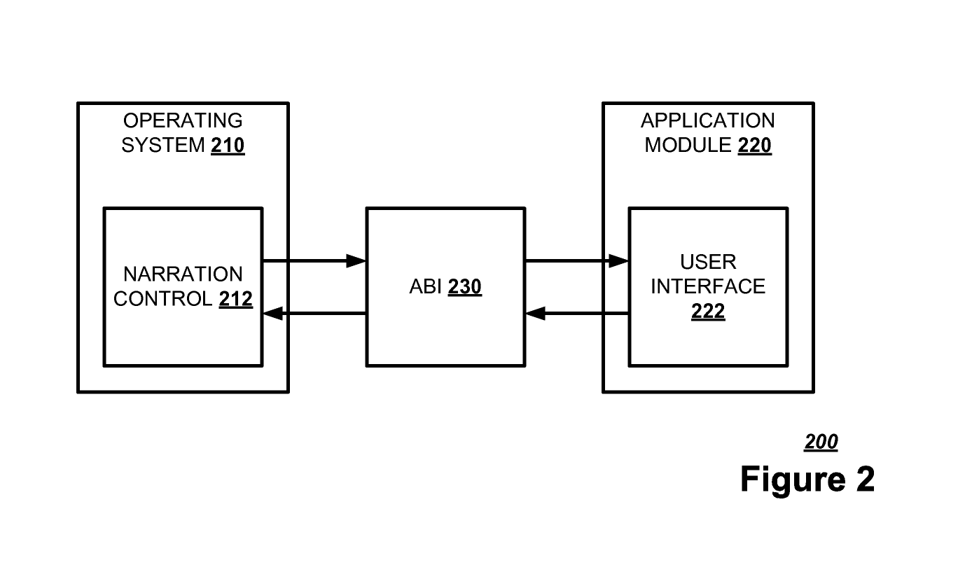

FIG. 2 illustrates, in a block diagram, one embodiment of a software application interaction 200. The computing device 100 may execute an operating system 210. An operating system 210 is a set of software applications that manage the use of hardware resources by an application module 220, as well as interactions between application modules 220. An application module 220 is a software application, or an aspect of a software application. An application module 220 may communicate with the operating system 210 via an application binary interface (ABI) 230. An application binary interface 230 is a tool allowing the application module 220 to access specific tools, functions, and calls provided by the operating system 210. One tool provided by the operating system 210 may be a narration control 212. A narration control 212 converts text from an application module 220 to an audio format to be played for a user. For example, the application module 220 may have a user interface 222 to receive inputs from a user via an input device 160. The narration control 212 may convert text in the user interface 222 to an audio format for presentation to the user.

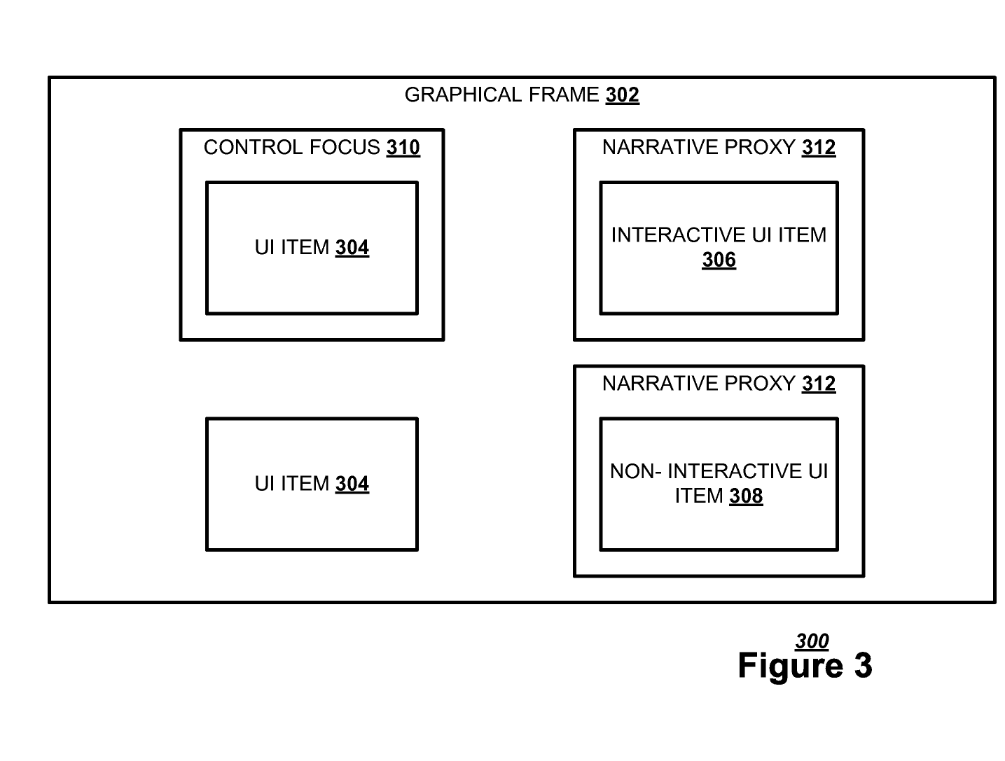

FIG. 3 illustrates, in a block diagram, one embodiment of a graphical user interface 300. The graphical user interface 300 may present in a graphical frame 302 one or more user interface (UI) items 304. A user interface item 304 may be a control or data shown in the graphical frame 302. An interactive user interface item 306 may be a user interface item 304 that, when selected by the user, may cause the application to perform a certain function, such as a control. A non-interactive user interface item 308 may be a user interface item 304 that displays information and does not cause the application to perform any functions when selected by the user, minus further actions.

A user may use the input device 160 to place a user interface item 304 under input control focus 310. Specifically, if a keyboard is the input device 160 used to apply input control focus 310, the input control focus 310 may be referred to as keyboard focus. The user may use a tab button to move keyboard focus between user interface items 304. Typically, the tab button may move keyboard focus between interactive user interface items 306, ignoring non-interactive user interface items 308. Other input devices besides a keyboard may be used to direct input control focus 310. A narration control 212 may vocalize the user interface item 304 under input control focus 310.

A developer may wrap a non-interactive user interface item 308 in a narrative proxy 312 to capture input control focus 310. The narrative proxy 312 may present as a tab stop to the narration control 212. A developer may wrap an interactive user interface item 306 in a narrative proxy 312 to provide the option of an alternate control function for the interactive user interface item 306. For example, if a user interface item 304 has a panoramic view that exceeds the width of the graphical frame 302, the narrative proxy 312 may be used to alert the user that pressing an alternate keyboard key may cause the graphical frame 302 to pan to the left or the right.

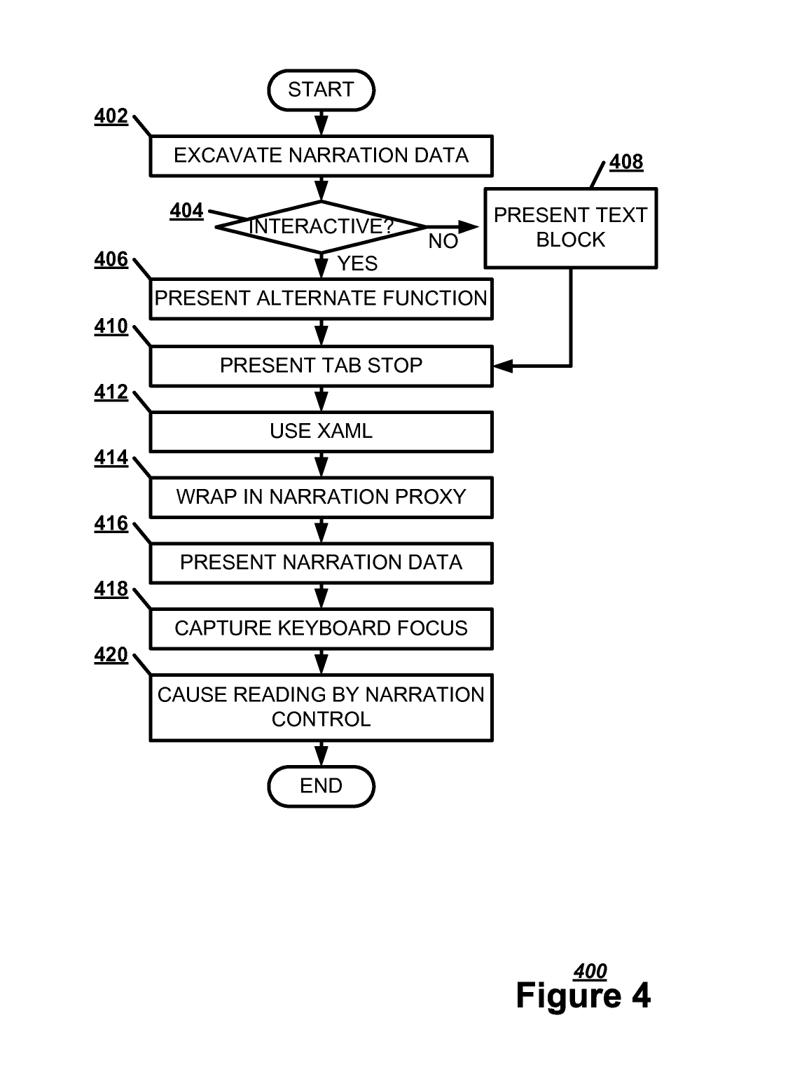

FIG. 4 illustrates, in a flowchart, one embodiment of a method for presenting a user interface item to a narration control. The application module 220 may excavate narration data from a user interface item 304 with a narration proxy 312 (Block 402). If the narration proxy 312 represents an interactive user interface item 306 (Block 404), the application module 220 may present an alternate control function for the interactive user interface item 306 to a narration control 212 using the narration proxy 312 (Block 406). If the narration proxy 312 represents a non-interactive user interface item 308 (Block 404), the application module 220 may present a text block with the narration proxy 312 (Block 408). The application module 220 may present the narration proxy 312 as a tab stop (Block 410). The application module 220 may use extensible application markup language (XAML) to implement the narration proxy 312 (Block 412). The application module 220 may wrap a user interface item 304 in the narration proxy 312 (Block 414). The application module 220 may present narration data for the user interface item 304 to a narration control 212 using the narration proxy 312 (Block 416). The application module 220 may capture keyboard focus using the narration proxy 312 (Block 418). The application module 220 may cause the user interface item 304 to be read by a narration control 212 using the narration proxy 312 (Block 420).

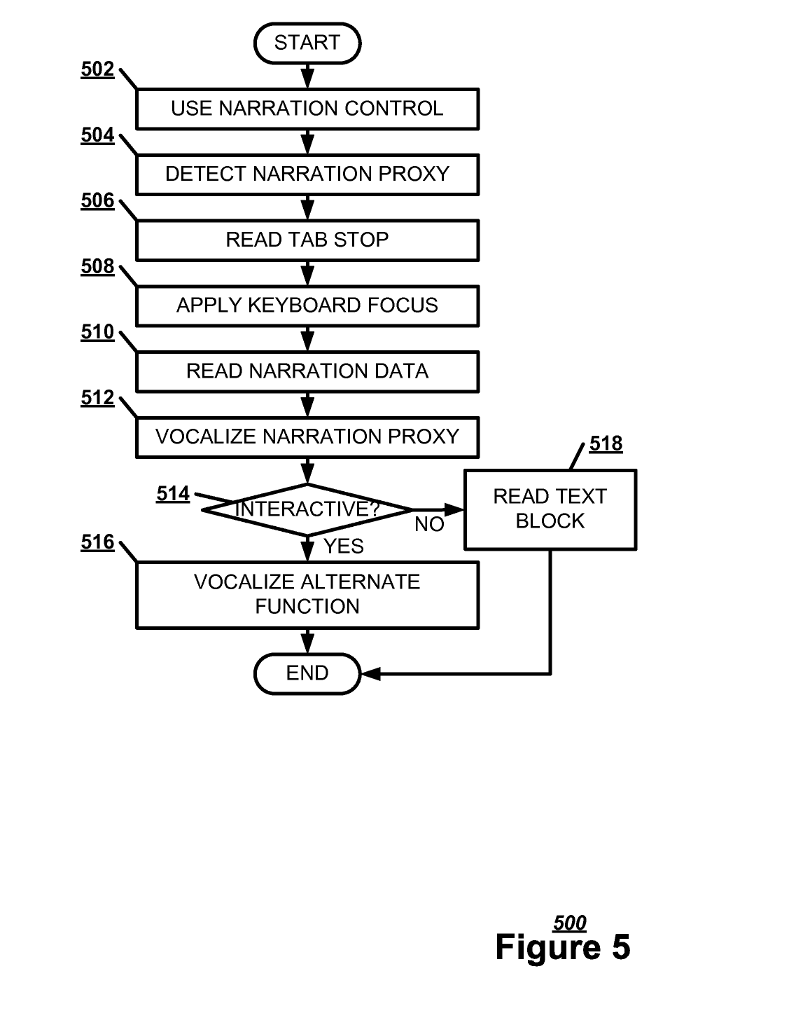

FIG. 5 illustrates, in a flowchart, one embodiment of a method for vocalizing a user interface item with a narration control. An operating system 210 may use a narration control 212 to vocalize a user interface 222 (Block 502). The operating system 210 may detect a narration proxy 312 representing a user interface item 304 (Block 504). The operating system 210 may read the narration proxy 312 as a tab stop (Block 506). The operating system 210 may apply keyboard focus to the narration proxy 312 (Block 508). The operating system 210 may read narration data from the narration proxy 312 for the user interface item 304 with the narration control 212 (Block 510). The operating system 210 may vocalize the user interface item 222 with the narration control 212 using the narration proxy 312 (Block 512). If the operating system 210 detects an interactive user interface item 306 with the narration proxy 312 (Block 514), the operating system 210 may vocalize an alternate control function for the interactive user interface item 306 (Block 516). If the operating system 210 detects a non-interactive user interface item 308 with the narration proxy 312 (Block 514), the operating system 210 may read a text block with the narration proxy 312 (Block 516).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
using a narration control of an operating system to vocalize a user interface;
detecting a narration proxy representing a user interface item; and
vocalizing the narration proxy with the narration control.

2. The method of claim 1, further comprising:
applying keyboard focus to the narration proxy.

3. The method of claim 1, further comprising:
reading the narration proxy as a tab stop.

4. The method of claim 1, further comprising:
reading narration data from the narration proxy.

5. The method of claim 1, further comprising:
reading narration data for the user interface item with the narration control.

6. The method of claim 1, further comprising:
detecting an interactive user interface item with the narration proxy.

7. The method of claim 6, further comprising:
vocalizing an alternate control function for the interactive user interface item.

8. The method of claim 1, further comprising:
detecting a non-interactive user interface item with the narration proxy.

9. The method of claim 1, further comprising:
reading a text block with the narration proxy.

10. A tangible machine-readable medium having a set of instructions detailing a method stored thereon that when executed by one or more processors cause the one or more processors to perform the method, the method comprising:
wrapping a user interface item in a narration proxy; and
causing the user interface item to be read by a narration control using the narration proxy.

11. The tangible machine-readable medium of claim 10, wherein the method further comprises:
capturing keyboard focus using the narration proxy.

12. The tangible machine-readable medium of claim 10, wherein the method further comprises:
presenting the narration proxy as a tab stop.

13. The tangible machine-readable medium of claim 10, wherein the method further comprises:
excavating narration data from the user interface item with the narration proxy.

14. The tangible machine-readable medium of claim 10, wherein the method further comprises:
presenting narration data for the user interface item to the narration control using the narration proxy.

15. The tangible machine-readable medium of claim 10, wherein the method further comprises:
representing an interactive user interface item with the narration proxy.

16. The tangible machine-readable medium of claim 15, wherein the method further comprises:
presenting an alternate control function for the interactive user interface item to the narration control using the narration proxy.

17. The tangible machine-readable medium of claim 10, wherein the method further comprises:
representing a non-interactive user interface item with the narration proxy.

18. The tangible machine-readable medium of claim 10, wherein the method further comprises:
using extensible application markup language to implement the narration proxy.

19. A user interface narrator, comprising:
a memory that stores a user interface with a narration proxy representing a non-interactive user interface item;
a processor that executes an operating system with a narration control that detects the narration proxy; and
an audio output that vocalizes the narration proxy with the narration control.

20. The user interface narrator of claim 19, wherein the narration proxy captures keyboard focus.
